(19) United States
(12) Patent Application Publication
(10) Pub. No.: US 2024/0311681 A1
(43) Pub. Date: Sep. 19, 2024

(54) METHOD AND SYSTEM FOR FACILITATING REAL-TIME AUTOMATED DATA ANALYTICS

(71) Applicant: JPMorgan Chase Bank, N.A., New York, NY (US)

(72) Inventors: Supriya SHAH, Mumbai (IN); Amit A WAGH, Singapore (SG); Dhaval S SAVLA, Mumbai (IN); Atulkumar PRASAD, Thane (IN); Ravi DHOKPANDE, Mumbai (IN)

(73) Assignee: JPMorgan Chase Bank, N.A., New York, NY (US)

(21) Appl. No.: 18/141,663

(22) Filed: May 1, 2023

(30) Foreign Application Priority Data
Mar. 17, 2023 (IN) 202311018291

(51) Int. Cl. G06N 20/00

(52) U.S. Cl. CPC G06N 20/00

(57) ABSTRACT

A method for facilitating automated data analytics in real-time via artificial intelligence is disclosed. The method includes automatically aggregating, in real-time, raw data from various sources, the sources including a source application that persists the raw data in a data storage container; triggering, by using a lambda function, a transformation process for the raw data; generating, based on an output of the transformation process, structured data sets from the aggregated raw data; persisting the structured data sets in a repository, the repository including a distributed database; determining, by using a machine learning model, predictive outputs based on the persisted structured data sets; and generating, in real-time, a dashboard by using the predictive outputs and the structured data sets.

### CROSS-REFERENCE TO RELATED APPLICATIONS

This application claims the benefit of Indian Non-Provisional Patent Application No. 202311018291, filed Mar. 17, 2023, which is hereby incorporated by reference in its entirety.

### BACKGROUND

### 1. Field of the Disclosure

This technology generally relates to methods and systems for data analytics, and more particularly to methods and systems for facilitating automated data analytics and automated data presentation in real-time via artificial intelligence and machine learning.

### 2. Background Information

Many business entities such as, for example, clearing brokers rely on complex data analytics to process raw data into usable information. Often, the raw data include vast amounts of files and records that have been aggregated from many different data platforms. Historically, implementations of conventional data analytic techniques have resulted in varying degrees of success with respect to providing timely insights that are accurate and resource efficient.

One drawback of implementing the conventional data analytic techniques is that in many instances, the resulting output may be stale because many additional processing steps are required before usable information may be extracted. As a result, insight into a particular condition such as, for example, a market state may only be derived after the particular condition has already changed. Additionally, without effective data functionalizing capabilities for the raw data, the conventional data analytic techniques do not facilitate a broad range of operations such as, for example, margin and risk data analytics, automated detection and alerting, as well as research capabilities onto user trends and patterns of risk exposures.

Therefore, there is a need for real-time, automated data analytics that reliably structure raw data from various different sources, leverage artificial intelligence as well as machine learning to provide useful insights, and improve communication via automated detection and alerts.

### SUMMARY

The present disclosure, through one or more of its various aspects, embodiments, and/or specific features or sub-components, provides, inter alia, various systems, servers, devices, methods, media, programs, and platforms for facilitating automated data analytics and automated data presentation in real-time via artificial intelligence and machine learning.

According to an aspect of the present disclosure, a method for facilitating automated data analytics in real-time via artificial intelligence is disclosed. The method is implemented by at least one processor. The method may include automatically aggregating, in real-time, raw data from at least one source, the at least one source may include a source application that persists the raw data in a data storage container; triggering, by using a lambda function, a transformation process for the raw data; generating, based on an output of the transformation process, at least one structured data set from the aggregated raw data; persisting the at least one structured data set in a repository, the repository may include a distributed database; determining, by using at least one model, at least one predictive output based on the persisted at least one structured data set; and generating, in real-time, at least one dashboard by using the at least one predictive output and the at least one structured data set.

In accordance with an exemplary embodiment, the method may further include exposing the at least one predictive output and the at least one structured data set by, automatically generating at least one documentation based on the at least one predictive output, the at least one structured data set, and at least one entitlement rule, the at least one documentation may include a selection of client data that corresponds to each of a plurality of clients; validating each of the at least one documentation based on a predetermined guideline to confirm content; and publishing the at least one documentation for a corresponding client.

In accordance with an exemplary embodiment, the method may further include alerting at least one client based on the at least one predictive output and the at least one structured data set by, automatically determining, by using the at least one model, whether at least one parameter exceeds a corresponding threshold; generating at least one alert notification based on a result of the automatic determining, the at least one alert notification may include a selection of information that corresponds to the at least one parameter, the corresponding threshold, the at least one predictive output, and the at least one structured data set; validating each of the at least one alert notification based on a predetermined guideline to confirm content; and transmitting the at least one alert notification to the corresponding at least one client.

In accordance with an exemplary embodiment, for the transformation process, the method may further include normalizing, by using the lambda function, the raw data across a plurality of data records and a plurality of data fields; and outputting the normalized raw data.

In accordance with an exemplary embodiment, to normalize the raw data, the method may further include identifying a plurality of data elements in the raw data, each of the plurality of data elements may correspond to an atomic unit of data with a distinct value; mapping each of the plurality of data elements based on the plurality of data records and the plurality of data fields; and organizing the plurality of data elements into at least one grouping based on a result of the mapping.

In accordance with an exemplary embodiment, the method may further include displaying, in real-time, the at least one dashboard via a graphical user interface, wherein the at least one dashboard may correspond to a visual representation of the at least one predictive output and the at least one structured data set; and wherein the at least one dashboard may include at least one from among a real-time risk view, a drill down view, a multiple currency view, and a forecast view.

In accordance with an exemplary embodiment, the at least one dashboard may include a client dashboard that is displayable for each of a plurality of clients based on a corresponding entitlement rule that governs data sharing, the client dashboard may include a selection of data from the at least one predictive output and the at least one structured data set that corresponds to each of the plurality of clients.

In accordance with an exemplary embodiment, the graphical user interface may correspond to an application that is compatible with a plurality of mobile computing devices, the application may include at least one from among a mobile application and a web application that is usable to facilitate interactions with the at least one dashboard.

In accordance with an exemplary embodiment, the at least one model may include at least one from among a machine learning model, a mathematical model, a process model, and a data model.

According to an aspect of the present disclosure, a computing device configured to implement an execution of a method for facilitating automated data analytics in real-time via artificial intelligence is disclosed. The computing device including a processor; a memory; and a communication interface coupled to each of the processor and the memory, wherein the processor may be configured to automatically aggregate, in real-time, raw data from at least one source, the at least one source may include a source application that persists the raw data in a data storage container; trigger, by using a lambda function, a transformation process for the raw data; generate, based on an output of the transformation process, at least one structured data set from the aggregated raw data; persist the at least one structured data set in a repository, the repository may include a distributed database; determine, by using at least one model, at least one predictive output based on the persisted at least one structured data set; and generate, in real-time, at least one dashboard by using the at least one predictive output and the at least one structured data set.

In accordance with an exemplary embodiment, the processor may be further configured to expose the at least one predictive output and the at least one structured data set by further causing the processor to, automatically generate at least one documentation based on the at least one predictive output, the at least one structured data set, and at least one entitlement rule, the at least one documentation may include a selection of client data that corresponds to each of a plurality of clients; validate each of the at least one documentation based on a predetermined guideline to confirm content; and publish the at least one documentation for a corresponding client.

In accordance with an exemplary embodiment, the processor may be further configured to alert at least one client based on the at least one predictive output and the at least one structured data set by further causing the processor to, automatically determine, by using the at least one model, whether at least one parameter exceeds a corresponding threshold; generate at least one alert notification based on a result of the automatic determining, the at least one alert notification may include a selection of information that corresponds to the at least one parameter, the corresponding threshold, the at least one predictive output, and the at least one structured data set; validate each of the at least one alert notification based on a predetermined guideline to confirm content; and transmit the at least one alert notification to the corresponding at least one client.

In accordance with an exemplary embodiment, for the transformation process, the processor may be further configured to normalize, by using the lambda function, the raw data across a plurality of data records and a plurality of data fields; and output the normalized raw data.

In accordance with an exemplary embodiment, to normalize the raw data, the processor may be further configured to identify a plurality of data elements in the raw data, each of the plurality of data elements may correspond to an atomic unit of data with a distinct value; map each of the plurality of data elements based on the plurality of data records and the plurality of data fields; and organize the plurality of data elements into at least one grouping based on a result of the mapping.

In accordance with an exemplary embodiment, the processor may be further configured to display, in real-time, the at least one dashboard via a graphical user interface, wherein the at least one dashboard may correspond to a visual representation of the at least one predictive output and the at least one structured data set; and wherein the at least one dashboard may include at least one from among a real-time risk view, a drill down view, a multiple currency view, and a forecast view.

In accordance with an exemplary embodiment, the at least one dashboard may include a client dashboard that is displayable for each of a plurality of clients based on a corresponding entitlement rule that governs data sharing, the client dashboard may include a selection of data from the at least one predictive output and the at least one structured data set that corresponds to each of the plurality of clients.

In accordance with an exemplary embodiment, the graphical user interface may correspond to an application that is compatible with a plurality of mobile computing devices, the application may include at least one from among a mobile application and a web application that is usable to facilitate interactions with the at least one dashboard.

In accordance with an exemplary embodiment, the at least one model may include at least one from among a machine learning model, a mathematical model, a process model, and a data model.

According to an aspect of the present disclosure, a non-transitory computer readable storage medium storing instructions for facilitating automated data analytics in real-time via artificial intelligence is disclosed. The storage medium including executable code which, when executed by a processor, may cause the processor to automatically aggregate, in real-time, raw data from at least one source, the at least one source may include a source application that persists the raw data in a data storage container; trigger, by using a lambda function, a transformation process for the raw data; generate, based on an output of the transformation process, at least one structured data set from the aggregated raw data; persist the at least one structured data set in a repository, the repository may include a distributed database; determine, by using at least one model, at least one predictive output based on the persisted at least one structured data set; and generate, in real-time, at least one dashboard by using the at least one predictive output and the at least one structured data set.

In accordance with an exemplary embodiment, when executed by the processor, the executable code may further cause the processor to display, in real-time, the at least one dashboard via a graphical user interface, wherein the at least one dashboard may correspond to a visual representation of the at least one predictive output and the at least one structured data set; and wherein the at least one dashboard may include at least one from among a real-time risk view, a drill down view, a multiple currency view, and a forecast view.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating automated data analytics and automated data presentation in real-time via artificial intelligence and machine learning.

FIG. 4 is a flowchart of an exemplary process for implementing a method for facilitating automated data analytics and automated data presentation in real-time via artificial intelligence and machine learning.

FIG. 5 is a flow diagram of an exemplary process for implementing a method for facilitating automated data analytics and automated data presentation in real-time via artificial intelligence and machine learning.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

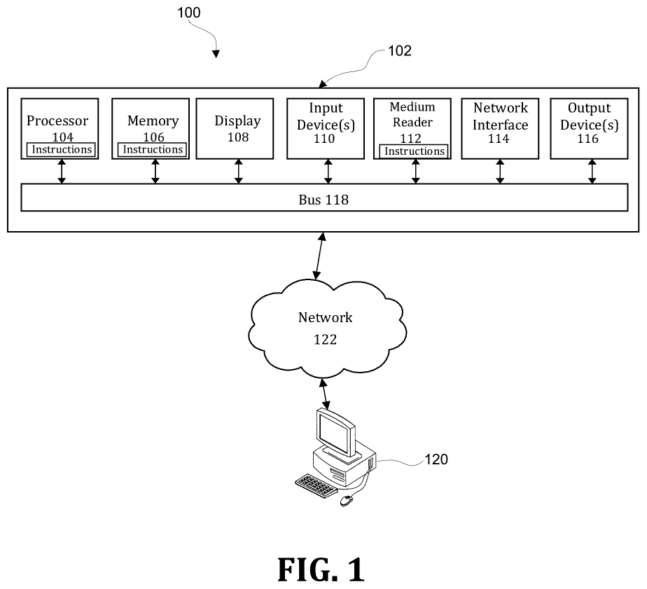

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating automated data analytics and automated data presentation in real-time via artificial intelligence and machine learning.

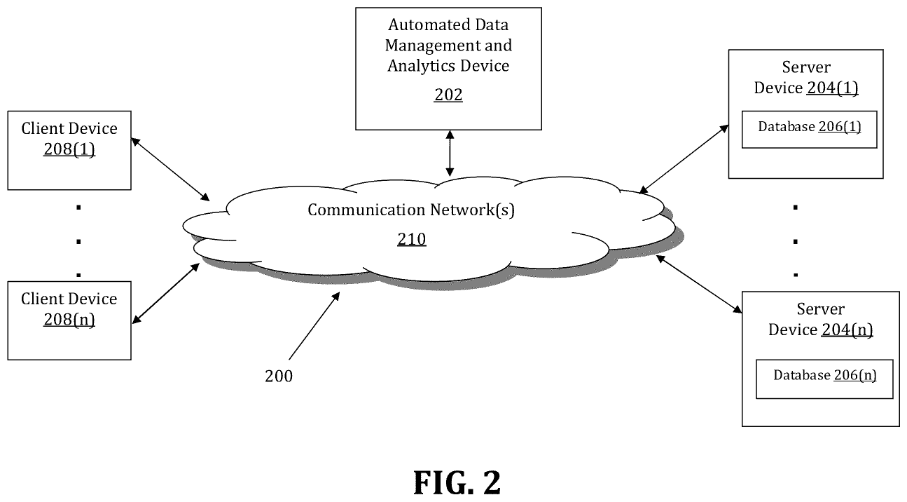

Referring to FIG. 2, a schematic of an exemplary network environment 200 for implementing a method for facilitating automated data analytics and automated data presentation in real-time via artificial intelligence and machine learning is illustrated. In an exemplary embodiment, the method is executable on any networked computer platform, such as, for example, a personal computer (PC).

The method for facilitating automated data analytics and automated data presentation in real-time via artificial intelligence and machine learning may be implemented by an Automated Data Management and Analytics (ADMA) device 202. The ADMA device 202 may be the same or similar to the computer system 102 as described with respect to FIG. 1. The ADMA device 202 may store one or more applications that can include executable instructions that, when executed by the ADMA device 202, cause the ADMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ADMA device 202 itself, may be located in virtual server(s) running in a cloud-based computing environment rather than being tied to one or more specific physical network computing devices. Also, the application(s) may be running in one or more virtual machines (VMs) executing on the ADMA device 202. Additionally, in one or more embodiments of this technology, virtual machine(s) running on the ADMA device 202 may be managed or supervised by a hypervisor.

In the network environment 200 of FIG. 2, the ADMA device 202 is coupled to a plurality of server devices 204(1)-204(n) that hosts a plurality of databases 206(1)-206(n), and also to a plurality of client devices 208(1)-208(n) via communication network(s) 210. A communication interface of the ADMA device 202, such as the network interface 114 of the computer system 102 of FIG. 1, operatively couples and communicates between the ADMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ADMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ADMA devices that efficiently implement a method for facilitating automated data analytics and automated data presentation in real-time via artificial intelligence and machine learning.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ADMA device 202 may be a standalone device or integrated with one or more other devices or apparatuses, such as one or more of the server devices 204(1)-204(n), for example. In one particular example, the ADMA device 202 may include or be hosted by one of the server devices 204(1)-204(n), and other arrangements are also possible. Moreover, one or more of the devices of the ADMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ADMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to raw data, futures data, margin data, risk data, structured data sets, predictive outputs, dashboards, documentations, and alert notifications.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ADMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ADMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ADMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ADMA device 202, the server devices 204(1)-204(n), or the client devices 208(1)-208(n), for example, may be configured to operate as virtual instances on the same physical machine. In other words, one or more of the ADMA device 202, the server devices 204(1)-204(n), or the client devices 208(1)-208(n) may operate on the same physical device rather than as separate devices communicating through communication network(s) 210. Additionally, there may be more or fewer ADMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

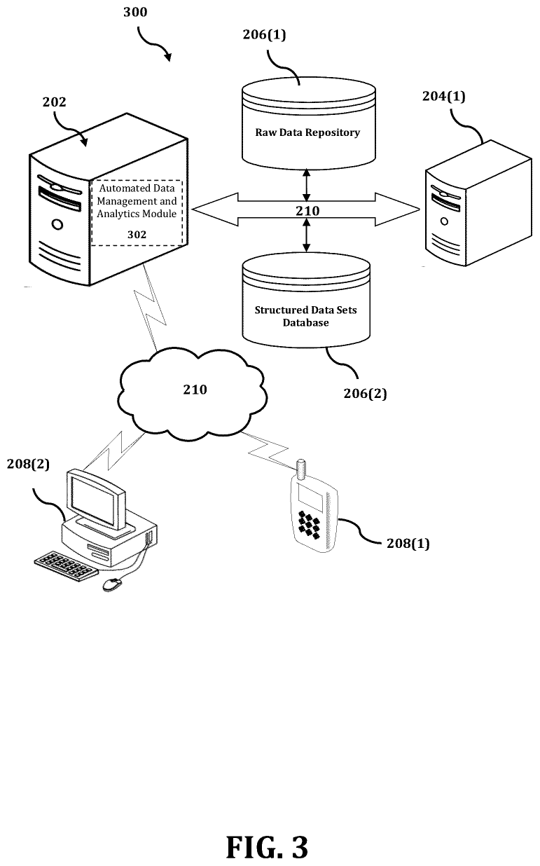

The ADMA device 202 is described and shown in FIG. 3 as including an automated data management and analytics module 302, although it may include other rules, policies, modules, databases, or applications, for example. As will be described below, the automated data management and analytics module 302 is configured to implement a method for facilitating automated data analytics and automated data presentation in real-time via artificial intelligence and machine learning.

An exemplary process 300 for implementing a mechanism for facilitating automated data analytics and automated data presentation in real-time via artificial intelligence and machine learning by utilizing the network environment of FIG. 2 is shown as being executed in FIG. 3. Specifically, a first client device 208(1) and a second client device 208(2) are illustrated as being in communication with ADMA device 202. In this regard, the first client device 208(1) and the second client device 208(2) may be “clients” of the ADMA device 202 and are described herein as such. Nevertheless, it is to be known and understood that the first client device 208(1) and/or the second client device 208(2) need not necessarily be “clients” of the ADMA device 202, or any entity described in association therewith herein. Any additional or alternative relationship may exist between either or both of the first client device 208(1) and the second client device 208(2) and the ADMA device 202, or no relationship may exist.

Further, ADMA device 202 is illustrated as being able to access a raw data repository 206(1) and a structured data sets database 206(2). The automated data management and analytics module 302 may be configured to access these databases for implementing a method for facilitating automated data analytics and automated data presentation in real-time via artificial intelligence and machine learning.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ADMA device 202 via broadband or cellular communication. Of course, these embodiments are merely exemplary and are not limiting or exhaustive.

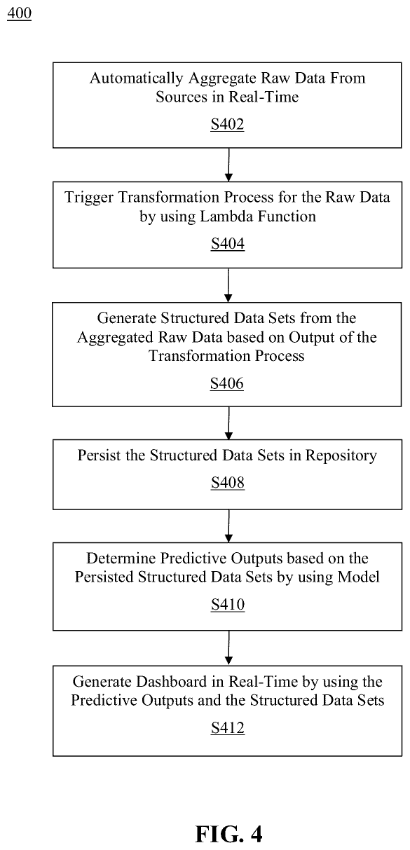

Upon being started, the automated data management and analytics module 302 executes a process for facilitating automated data analytics and automated data presentation in real-time via artificial intelligence and machine learning. An exemplary process for facilitating automated data analytics and automated data presentation in real-time via artificial intelligence and machine learning is generally indicated at flowchart 400 in FIG. 4.

In the process 400 of FIG. 4, at step S402, raw data may be automatically aggregated from various sources. The raw data may be automatically aggregated in real-time. In an exemplary embodiment, the raw data may include unstructured data in a variety of data formats. The raw data may relate to a collection of information as gathered from the sources before the collection has been further processed, cleaned, and/or analyzed. In another exemplary embodiment, the raw data may include any variety of data types such as, for example, alphabetic characters, numeric characters, and symbols. Likewise, the raw data may represent any data attribute such as, for example, financial data.

In another exemplary embodiment, the raw data may include portfolio related financial data such as, for example, margin data, portfolio position data, and balance data. The portfolio related financial data may be aggregated from first-party and third-party sources for a given portfolio. In another exemplary embodiment, the raw data may include market related financial data that relates to a state of a financial market such as, for example, a stock market. The market related financial data may correspond to general financial data such as, for example, a stock price that is retrieved from first-party and third-party sources.

In another exemplary embodiment, the raw data may be automatically aggregated in real-time from a data stream. For instance, access to a data stream from a data vendor may enable the automated extraction, aggregation, and compilation of the raw data in real-time from the data stream. Consistent with present disclosures, the raw data may be aggregated in real-time as well as near real-time as required based on technological and policy constraints.

In another exemplary embodiment, the raw data may be automatically aggregated according to a predetermined condition. The predetermined condition may include an aggregation schedule as well as a triggering event. For example, the aggregation schedule may dictate that the raw data is automatically aggregated every five, ten, and/or fifteen minutes. Similarly, in another example, the triggering event may dictate that the raw data is automatically aggregated when new information is available from a data vendor.

In an exemplary embodiment, the sources may include a source application that persists the raw data in a data storage container. The source application may correspond to a computer program that is designed to carry out specific tasks such as, for example, aggregating the raw data and persisting the raw data in a data storage container. In another exemplary embodiment, the source application may directly place the data in a data bucket of a cloud object storage system. Alternately, the source system may use a file transfer protocol such as, for example, Secure Shell (SSH) File Transfer Protocol (SFTP) to place the raw data directly in a server location.

At step S404, a transformation process for the raw data may be triggered by using a lambda function. In an exemplary embodiment, the lambda function may correspond to an anonymous function that relates to a function definition which is not bound to an identifier. The lambda function may include arguments that are passed to higher-order functions and/or used for constructing a result of a higher-order function that needs to return a function. The lambda function may take any number of arguments but can only have one expression.

In another exemplary embodiment, the lambda function may relate to a computing service in a cloud platform that enables code to be run without provisioning and/or managing servers. The computing service may execute code on a high-availability compute infrastructure and performs all the administration of the compute resources such as, for example, server and operating system maintenance, capacity provisioning and automatic scaling, as well as logging.

In another exemplary embodiment, the transformation process may include normalizing the raw data and outputting the normalized raw data to appropriate downstream computing components. The raw data may be normalized across a plurality of data records and a plurality of data fields by using a lambda function. More specifically, normalizing the raw data may include identifying a plurality of data elements in the raw data. Each of the plurality of data elements may correspond to an atomic unit of data with a distinct value. After identification, each of the plurality of data elements may be mapped based on the plurality of data records and the plurality of data fields. The plurality of data elements may be organized into groupings based on a result of the mapping. The groupings may include a least one from among a margin data grouping, a position data grouping, an account data grouping, an entitlement data grouping, a foreign exchange rate data grouping, a product data grouping, and a balance data grouping.

Alternately, a spring boot application hosted on a server may poll a folder for incoming files to facilitate the transformation process. Consistent with present disclosures, the transformation process may include normalizing the raw data and outputting the normalized raw data to appropriate downstream computing components.

At step S406, structured data sets may be generated from the aggregated raw data. The structured data sets may be generated based on an output of the transformation process. In an exemplary embodiment, the structured data sets may relate to a collection of data in a standardized format that has a well-defined structure. The structured data sets may comply with a predetermined data model, follow a persistent order, and is easily accessible by networked computing components. For example, the structured data sets may structure data in rows and columns for storage in a database. In another exemplary embodiment, the structured data sets may be generated based on a mapping of the data elements as outputted by the transformation process. For example, the transformation process may output a specific asset price together with a mapping that is usable to place the specific asset price in an asset price column.

At step S408, the structured data sets may be persisted in a repository. In an exemplary embodiment, the repository may include a distributed database. In an exemplary embodiment, the structured data sets may be persisted in a managed non-relational structured query language (NOSQL) database service that supports key-value and document data structures. The NOSQL database may provide a mechanism for storage and retrieval of data that is modeled in processes other than the tabular relations used in relational databases. In another exemplary embodiment, the structured data sets may be persisted in a multi-model database management system. The multi-model database management system may be available via on-premises computing, on-cloud computing, or as a hybrid cloud installation.

At step S410, predictive outputs may be determined based on the persisted structured data sets. The predictive outputs may be determined by using a model. In an exemplary embodiment, the structured data sets may be loaded into a computing environment that leverages models such as, for example, machine learning models to facilitate predictive analytics. The computing environment may utilize the models to provide assessments of the structured data sets such as, for example, risk and margin analytics, as well as provide predictive outputs that include predictions of potential outcomes related to the structured data sets. Consistent with present disclosures, the predictive outputs may be usable to facilitate visualization of the structured data. The visualizations may include real-time risk visualizations, drill-down approach visualization, multiple currency visualization, and forecasted visualizations.

In another exemplary embodiment, the model may include at least one from among a machine learning model, a mathematical model, a process model, and a data model. The model may correspond to artificial intelligence algorithms for forecasting such as, for example, time series models, econometric models, judgmental forecasting models, and group opinion (DELPHI method) models. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S412, dashboards may be generated by using the predictive outputs and the structured data sets. The dashboards may be generated and available for viewing in real-time. In an exemplary embodiment, the dashboards may correspond to a graphical summary of various pieces of information in the predictive outputs and the structured data sets. The various pieces of information may be selected for visualization to give an overview the predictive outputs and the structured data sets. In another exemplary embodiment, the dashboards may relate to a display of the various pieces of information in one visualization. The dashboards may be usable to convey different, but related information in an easy-to-digest format.

In another exemplary embodiment, the dashboards may include a graphical user interface that visually represents the various pieces of information as graphical elements such as, for example, tables, charts, and graphs. The graphical user interface may facilitate interactions with a user by receiving inputs from the user. In another exemplary embodiment, the dashboards may be displayed via the graphical user interface in real-time with disclosed outputs. The dashboards may correspond to a visual representation of the predictive output and the structured data sets. Consistent with present disclosures, the dashboards may include at least one from among a real-time risk view, a drill down view, a multiple currency view, and a forecast view.

In another exemplary embodiment, the dashboards may include a client dashboard that is displayable for each of a plurality of clients based on a corresponding entitlement rule that governs data sharing. The client dashboard may include a selection of data from the predictive outputs and the structured data sets that corresponds to each of the plurality of clients. In another exemplary embodiment, the graphical user interface may correspond to an application that is compatible with a plurality of mobile computing devices. The application may include at least one from among a mobile application and a web application that is usable to facilitate interactions with the dashboards. For example, the application may enable a user to analyze data on the dashboards by asking questions in a natural language format, interactively explore the data on the dashboards, and/or automatically look for patterns and outliers.

In another exemplary embodiment, the web application may correspond to application software that runs on a web server. Unlike computer-based software programs that run locally on the operating system of a device, the web application may be accessed by the user through a web browser with an active network connection. The web application may be programmed by using a client-server modeled structure wherein the user is provided services via an off-site server. The off-site server may include first-party off-site servers as well as third-party off-site servers.

In another exemplary embodiment, the predictive outputs and the structured data sets may be exposed for consumption by an end-user such as, for example, a client. To expose the data, documentation may be automatically generated based on the predictive outputs, the structured data sets, and entitlement rules. The documentation may include a selection of client specific data that corresponds to each of a plurality of clients. The documentation may then be validated based on a predetermined guideline to confirm content. The predetermined guideline may correspond to at least one from among an operating guideline and a regulatory guideline that governs the dissemination of data. The predetermined guideline may also include requirements that the documentation is validated by an administrator to ensure compliance. Once validated, the documentation may be published for a corresponding client.

In another exemplary embodiment, a client may be alerted based on the predictive output and the structured data set. The client may be automatically alerted without additional user input as well as in an ad hoc manner as initiated by the user. Prior to alerting the client, whether parameters such as, for example, risk and margin exposure parameters exceed a corresponding threshold may be automatically determined. The automatic determination may be made by using the model. Alert notifications may be generated based on a result of the automatic determining. The alert notifications may include a selection of information that corresponds to the parameters, the corresponding threshold, the predictive outputs, and the structured data sets.

Then, consistent with present disclosures, each of the alert notifications may be validated based on a predetermined guideline to confirm content. The predetermined guideline may correspond to at least one from among an operating guideline and a regulatory guideline that governs the dissemination of data. The predetermined guideline may also include requirements that the documentation is validated by an administrator to ensure compliance. Once validated, the alert notifications may be transmitted to the corresponding client.

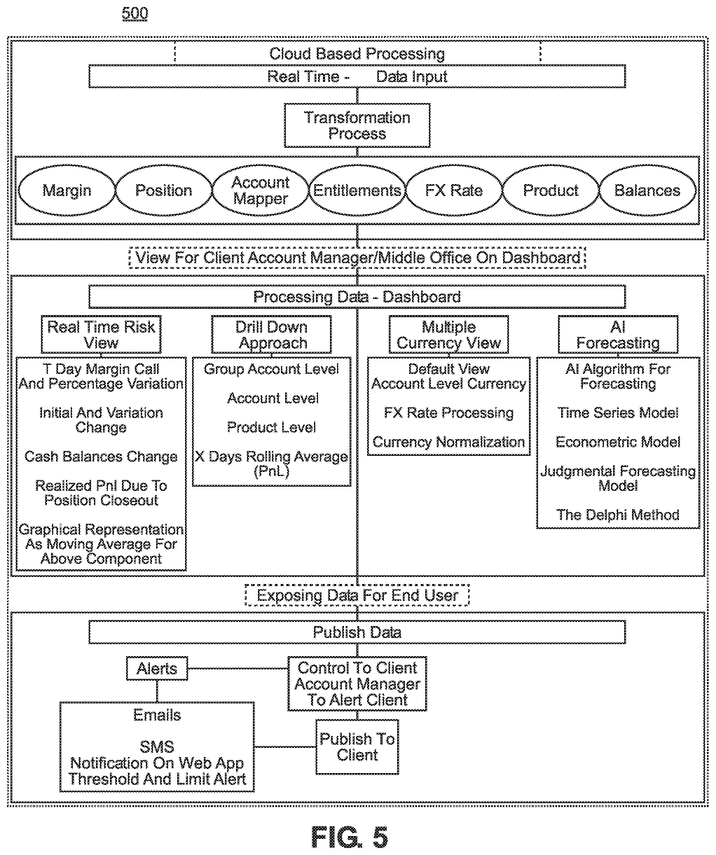

FIG. 5 is a flow diagram 500 of an exemplary process for implementing a method for facilitating automated data analytics and automated data presentation in real-time via artificial intelligence and machine learning. In FIG. 5, raw data may be processed in a cloud-based computing environment consistent with present disclosures.

As illustrated in FIG. 5, data inputs such as, for example, raw data may be received in real-time. The data inputs may include margin data, position data, and balance data from source applications. Then, a transformation process may be initiated to normalize the data inputs for data structuring and grouping. The normalized data may be structured according to groupings such as, for example, margin data groupings, position data groupings, account mapper data groupings, entitlements data groupings, foreign exchange rate data groupings, product data groupings, and balance data groupings. Then, the normalized data may be persisted in a database.

The persisted, normalized data may be further processed, and dashboards may be generated. The dashboards may provide views of the processed data for internal personnel such as, for example, client account managers and middle office managers. The views may include real-time risk views, drill down approach views, multiple currency views, and artificial intelligence forecasting views. The drill down approach view may enable a user to closely examine data components that make up a particular data point based on an association between the data components and the particular data point. For example, the user may closely examine a specific portfolio by drilling down to an account level from a group account level.

Additionally, the processed data may be augmented with machine learning. Augmenting the processed data with machine learning may enable automated narratives, machine learning predictions, natural language questions, anomaly detection, and forecasting. The automated narratives feature may summarize business metrics in plain language to enhance understanding of the data. The machine learning predictions feature may visualize and build predictive dashboards. The natural language questions feature may enable a user to ask questions related to the data in a natural language. The anomaly detection feature may facilitate discovery of unexpected trends and outliers against large quantities of business metrics. The forecasting feature may enable machine learning forecasting with point-and-click simplicity.

Further, the processed data may also be exposed for end users such as, for example, external parties and clients. A publishing component may be usable to expose the data consistent with present disclosures. The publishing component may compile data for each end user based on a corresponding entitlement rule. Approval from a client account manager may be required in advance of any data publication to end users to ensure data fidelity. Then, the processed data may be published to the end users as an alert and/or as a documentation of the processed data. The processed data may be published to the end users via email systems, enterprise chat systems, short messaging service (SMS) systems, and notification systems on a corresponding web application.

Accordingly, with this technology, an optimized process for facilitating automated data analytics and automated data presentation in real-time via artificial intelligence and machine learning is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating automated data analytics in real-time via artificial intelligence, the method being implemented by at least one processor, the method comprising:
automatically aggregating, by the at least one processor in real-time, raw data from at least one source, the at least one source including a source application that persists the raw data in a data storage container;
triggering, by the at least one processor using a lambda function, a transformation process for the raw data;
generating, by the at least one processor based on an output of the transformation process, at least one structured data set from the aggregated raw data;
persisting, by the at least one processor, the at least one structured data set in a repository, the repository including a distributed database;
determining, by the at least one processor using at least one model, at least one predictive output based on the persisted at least one structured data set; and
generating, by the at least one processor in real-time, at least one dashboard by using the at least one predictive output and the at least one structured data set.

2. The method of claim 1, further comprising:
exposing, by the at least one processor, the at least one predictive output and the at least one structured data set by,
automatically generating, by the at least one processor, at least one documentation based on the at least one predictive output, the at least one structured data set, and at least one entitlement rule, the at least one documentation including a selection of client data that corresponds to each of a plurality of clients;
validating, by the at least one processor, each of the at least one documentation based on a predetermined guideline to confirm content; and
publishing, by the at least one processor, the at least one documentation for a corresponding client.

3. The method of claim 1, further comprising:
alerting, by the at least one processor, at least one client based on the at least one predictive output and the at least one structured data set by,
automatically determining, by the at least one processor using the at least one model, whether at least one parameter exceeds a corresponding threshold;
generating, by the at least one processor, at least one alert notification based on a result of the automatic determining, the at least one alert notification including a selection of information that corresponds to the at least one parameter, the corresponding threshold, the at least one predictive output, and the at least one structured data set;
validating, by the at least one processor, each of the at least one alert notification based on a predetermined guideline to confirm content; and
transmitting, by the at least one processor, the at least one alert notification to the corresponding at least one client.

4. The method of claim 1, wherein the transformation process further comprises:
normalizing, by the at least one processor using the lambda function, the raw data across a plurality of data records and a plurality of data fields; and
outputting, by the at least one processor, the normalized raw data.

5. The method of claim 4, wherein normalizing the raw data further comprises:
identifying, by the at least one processor, a plurality of data elements in the raw data, each of the plurality of data elements corresponding to an atomic unit of data with a distinct value;
mapping, by the at least one processor, each of the plurality of data elements based on the plurality of data records and the plurality of data fields; and
organizing, by the at least one processor, the plurality of data elements into at least one grouping based on a result of the mapping.

6. The method of claim 1, further comprising:
displaying, by the at least one processor in real-time, the at least one dashboard via a graphical user interface,
wherein the at least one dashboard corresponds to a visual representation of the at least one predictive output and the at least one structured data set; and
wherein the at least one dashboard includes at least one from among a real-time risk view, a drill down view, a multiple currency view, and a forecast view.

7. The method of claim 6, wherein the at least one dashboard includes a client dashboard that is displayable for each of a plurality of clients based on a corresponding entitlement rule that governs data sharing, the client dashboard including a selection of data from the at least one predictive output and the at least one structured data set that corresponds to each of the plurality of clients.

8. The method of claim 6, wherein the graphical user interface corresponds to an application that is compatible with a plurality of mobile computing devices, the application including at least one from among a mobile application and a web application that is usable to facilitate interactions with the at least one dashboard.

9. The method of claim 1, wherein the at least one model includes at least one from among a machine learning model, a mathematical model, a process model, and a data model.

10. A computing device configured to implement an execution of a method for facilitating automated data analytics in real-time via artificial intelligence, the computing device comprising:
a processor;
a memory; and
a communication interface coupled to each of the processor and the memory,
wherein the processor is configured to:
automatically aggregate, in real-time, raw data from at least one source, the at least one source including a source application that persists the raw data in a data storage container;
trigger, by using a lambda function, a transformation process for the raw data;
generate, based on an output of the transformation process, at least one structured data set from the aggregated raw data;
persist the at least one structured data set in a repository, the repository including a distributed database;
determine, by using at least one model, at least one predictive output based on the persisted at least one structured data set; and
generate, in real-time, at least one dashboard by using the at least one predictive output and the at least one structured data set.

11. The computing device of claim 10, wherein the processor is further configured to:
expose the at least one predictive output and the at least one structured data set by further causing the processor to,
automatically generate at least one documentation based on the at least one predictive output, the at least one structured data set, and at least one entitlement rule, the at least one documentation including a selection of client data that corresponds to each of a plurality of clients;
validate each of the at least one documentation based on a predetermined guideline to confirm content; and
publish the at least one documentation for a corresponding client.

12. The computing device of claim 10, wherein the processor is further configured to:
alert at least one client based on the at least one predictive output and the at least one structured data set by further causing the processor to,
automatically determine, by using the at least one model, whether at least one parameter exceeds a corresponding threshold;
generate at least one alert notification based on a result of the automatic determining, the at least one alert notification including a selection of information that corresponds to the at least one parameter, the corresponding threshold, the at least one predictive output, and the at least one structured data set;
validate each of the at least one alert notification based on a predetermined guideline to confirm content; and
transmit the at least one alert notification to the corresponding at least one client.

13. The computing device of claim 10, wherein, for the transformation process, the processor is further configured to:
normalize, by using the lambda function, the raw data across a plurality of data records and a plurality of data fields; and
output the normalized raw data.

14. The computing device of claim 13, wherein, to normalize the raw data, the processor is further configured to:
identify a plurality of data elements in the raw data, each of the plurality of data elements corresponding to an atomic unit of data with a distinct value;
map each of the plurality of data elements based on the plurality of data records and the plurality of data fields; and
organize the plurality of data elements into at least one grouping based on a result of the mapping.

15. The computing device of claim 10, wherein the processor is further configured to:
display, in real-time, the at least one dashboard via a graphical user interface,
wherein the at least one dashboard corresponds to a visual representation of the at least one predictive output and the at least one structured data set; and
wherein the at least one dashboard includes at least one from among a real-time risk view, a drill down view, a multiple currency view, and a forecast view.

16. The computing device of claim 15, wherein the at least one dashboard includes a client dashboard that is displayable for each of a plurality of clients based on a corresponding entitlement rule that governs data sharing, the client dashboard including a selection of data from the at least one predictive output and the at least one structured data set that corresponds to each of the plurality of clients.

17. The computing device of claim 15, wherein the graphical user interface corresponds to an application that is compatible with a plurality of mobile computing devices, the application including at least one from among a mobile application and a web application that is usable to facilitate interactions with the at least one dashboard.

18. The computing device of claim 10, wherein the at least one model includes at least one from among a machine learning model, a mathematical model, a process model, and a data model.

19. A non-transitory computer readable storage medium storing instructions for facilitating automated data analytics in real-time via artificial intelligence, the storage medium comprising executable code which, when executed by a processor, causes the processor to:
automatically aggregate, in real-time, raw data from at least one source, the at least one source including a source application that persists the raw data in a data storage container;
trigger, by using a lambda function, a transformation process for the raw data;
generate, based on an output of the transformation process, at least one structured data set from the aggregated raw data;
persist the at least one structured data set in a repository, the repository including a distributed database;
determine, by using at least one model, at least one predictive output based on the persisted at least one structured data set; and
generate, in real-time, at least one dashboard by using the at least one predictive output and the at least one structured data set.

20. The storage medium of claim 19, wherein, when executed by the processor, the executable code further causes the processor to:
display, in real-time, the at least one dashboard via a graphical user interface,
wherein the at least one dashboard corresponds to a visual representation of the at least one predictive output and the at least one structured data set; and
wherein the at least one dashboard includes at least one from among a real-time risk view, a drill down view, a multiple currency view, and a forecast view.
